(19) United States
(12) Patent Application Publication
(10) Pub. No.: US 2016/0223171 A1
(43) Pub. Date: Aug. 4, 2016

(54) POWERED MOUNTING CLIPS FOR MOUNTING DECORATIVE ARTICLES

(71) Applicant: GIBBONS INNOVATIONS, Lincoln, DE (US)

(72) Inventors: Christopher J. GIBBONS, Lincoln, DE (US); Jeffrey S. GIBBONS, Lincoln, DE (US)

(73) Assignee: Gibbons Innovations, Inc., Lincoln, DE (US)

(21) Appl. No.: 14/773,393

(22) PCT Filed: Mar. 12, 2014
(86) PCT No.: PCT/US14/24107

§ 371 Date: Sep. 8, 2015

Related U.S. Application Data
(60) Provisional application No. 61/777,599, filed on Mar. 12, 2013.

(51) Int. Cl. F21V 21/088; H01R 31/06; H01R 24/58; F21V 23/06; H01R 13/03; H02J 7/35; F21S 9/03; H01R 33/18; H01R 13/22

(52) U.S. Cl. CPC F21V 21/088; H01R 33/18; H01R 31/065; H01R 24/58; H01R 13/22; H01R 13/03; H02J 7/355; F21S 9/03; F21V 23/06; F21W 2121/004

(57) ABSTRACT

Mounting clips (10, 100, 200, 300, 400, 500, 600, 700, 800) removably engage to vertically disposed mounting surfaces, such as rain gutter downspouts. The mounting clips support hooks, arms, plates, decorations, and brackets for display of banners, flags, security lights, decorative lights, etc., on a downspout or other comparable mounting surface. The mounting clips include a frame (12) having arms (14) with projections (30) separated by channels (32) configured for attachment to a profiled outer surface of the mounting surface. Mounting clips (800) may incorporate power connections to power decorative articles connected to the mounting clips. A plurality of mounting clips with power connections may be joined together in series to form a system or grid (1000). Such system may be adapted for connection to power sources, including batteries, such as batteries associated with solar panels (1010).

### CROSS-REFERENCE TO RELATED APPLICATIONS

This application is a national stage application (under 35 USC §371) of PCT/US2014/024107, filed Mar. 12, 2014, which claims benefit of U.S. application No. 61/777,599, filed Mar. 12, 2013.

### BACKGROUND

The field of the present invention relates to mounting clips configured to mount onto a rain gutter downspout, household post, deck post, tree, pole, various sizes of lumber, doorway, or other comparable mounting surface.

Homeowners frequently mount various types of items onto the exterior of a building structure, including security lights, decorative lights, flags, and seasonal decorations. Many times, however, these items are not easily mounted onto building exteriors. Security lights, for example, are usually mounted onto exterior corners of buildings, using screws and specially designed mounting brackets. Decorative lights are often mounted with hook-type attachments, which are nailed or screwed into the building exterior or joined to horizontally disposed rain gutters. Flag mounts and other types of seasonal decorations are similarly mounted to building exteriors, using special attachments which are screwed or nailed into place.

Unfortunately, when lights, flags, decorations, and other mountable elements are not in use, the mounting devices used to attach these lights and decorations are left behind, potentially decreasing the aesthetic value of the building. In addition, when these mounting devices and their respective fastening elements are removed, damage made during installation is revealed. Depending on the material of the building structure, after removal of these elements, scratches, holes, cracks, rips, and tears in building exteriors are apparent. Besides negatively affecting the aesthetic appearance of building exteriors, the resulting damage may also provide entry sites for insects, water, wind, and dirt.

Various types of solutions have been proposed to attach lights, flags, decorations and other types of mountable elements to building exteriors. However, few solutions allow for attachment to a building structure without penetrating the structure's exterior. Moreover, few, if any, of these proposed solutions have considered attaching mountable elements, such as lights and decorations to rain gutter downspouts and other comparable vertically disposed mounting surfaces.

Downspouts, which are also commonly known as waterspouts, down pipes, drain spouts, and drain pipes, are vertically positioned conduits which are coupled to horizontally positioned gutters to carry rainwater from a gutter to ground level. Downspouts primarily direct water away from a building's foundation. By using downspouts, water may be directed to a sewer, rain collection area, or to the ground at a distance from a building foundation. Downspouts generally are positioned vertically against exterior building walls, and typically are coupled to building exteriors using straps positioned at various points along the vertical length of the downspout. Although some proposed solutions have considered clip-type attachments for decorative lights to horizontally-positioned gutters disposed along a roofline, these attachments are not adaptable to the shape and configuration of downspouts and other comparable vertically disposed mounting surfaces.

For these reasons, among others, there is a clear need for improved mounting clips used to mount lights, decorations, and other types of mountable elements. More particularly, a need exists for mounting clips that may be installed and removed repeatedly without causing significant harm to the supporting structure. The present invention fulfills these needs and provides further related advantages, as described in the following summary.

### SUMMARY

In one aspect of the invention, a mounting clip is configured for attachment to a downspout or other comparable mounting surface. The mounting clip includes a frame having a plurality of extending arms and a central portion disposed between at least two of the plurality of extending arms.

In one mounting clip configuration, a blank receiving area, configured to mate with a blank, is defined in the central portion. Various types of mountable elements may be coupled to the blank, including hooks, clips, arms, and mounting plates. The extending arms, central portions and/or rear portions of the frame may include projections and channels, which are complementary to the mounting surface such that the clip engages with the surface without the need for fastening elements.

Variations include incorporating electrical connectors or conductive leads into the frame that are adapted for electrical communication with powered elements of decorative articles. The powered mounting clips may be electrically joined together, such as by wire connections, to form an integrated system of powered mounting clips. The powered mounting clips may be joined to power sources, such as batteries, and particularly battery packs associated with solar panels. The powered mounting clips may be linked in series with other powered accessories, such as staked lights, strings of lights and holiday decorations with movable parts or appendages.

A more complete understanding of the invention, including an understanding of the various configurations of mounting clips and decorative mounting articles, will be afforded to those skilled in the art, as well as a realization of additional advantages and objects thereof, by consideration of the followed detailed description. Reference will be made to the appended drawing sheets which will first be described briefly.

### BRIEF DESCRIPTION OF THE DRAWINGS

The drawings described herein are for illustrative purposes only and are not intended to limit the scope of the present disclosure. In the drawings, wherein like reference numerals refer to similar components:

FIG. 1 is a right perspective view of one configuration of a mounting clip positioned for alignment onto a downspout;

FIG. 2 is a left perspective view of the mounting clip shown in FIG. I;

FIG. 3A is a right perspective view of the mounting clip shown in FIG. I and a blank positioned in alignment with a blank receiving area on the clip;

FIG. 3B is a right perspective view of an alternative embodiment of the first configuration of a mounting clip with a blank therein, wherein said blank is coupled to a flag or banner attachment;

FIG. 3C is a right perspective view of another alternative embodiment of the first configuration of a mounting clip with a blank therein, wherein said blank is coupled to a hook attachment;

FIG. 4A is a right perspective view of a second configuration of a mounting clip;

FIG. 4B is a right perspective view of a third configuration of a mounting clip;

FIG. 5 is a front view of the mounting clip configuration shown in FIG. 4;

FIG. 6 is a right perspective view of a fourth configuration of a mounting clip;

FIG. 7 is a right perspective view of a mounting clip assembly;

FIG. 8 is a right perspective view of a fifth configuration of a mounting clip;

FIG. 9A is a top view of a mounting clip configuration shown in FIG. 8;

FIG. 9B is a top view of a sixth mounting clip configuration;

FIG. 10 is a right perspective view of a decorative article coupled to a mounting clip;

FIG. 11 is a right perspective view of a decorative article having an integrated mounting clip;

FIG. 12 is a perspective view of one mounting clip configuration mounted onto a vertical post;

FIG. 13 is a schematic perspective view of a house featuring a solar-powered display system that includes solar panels and battery packs in electrical communication with several mounting clips and several other powered elements, such as staked light bulbs and strings of light bulbs;

FIG. 14 is a partially exploded right perspective view showing a powered mounting clip assembly with a powered mounting clip and mating blank;

FIG. 15 is a right perspective view of the powered mounting clip assembly of FIG. 14, installed onto a vertical downspout or post;

FIG. 16 is a cross-sectional view taken along line 16-16 in FIGS. 14; and

FIG. 17 is a cross-sectional view taken along line 17-17 in FIG. 15.

### DETAILED DESCRIPTION

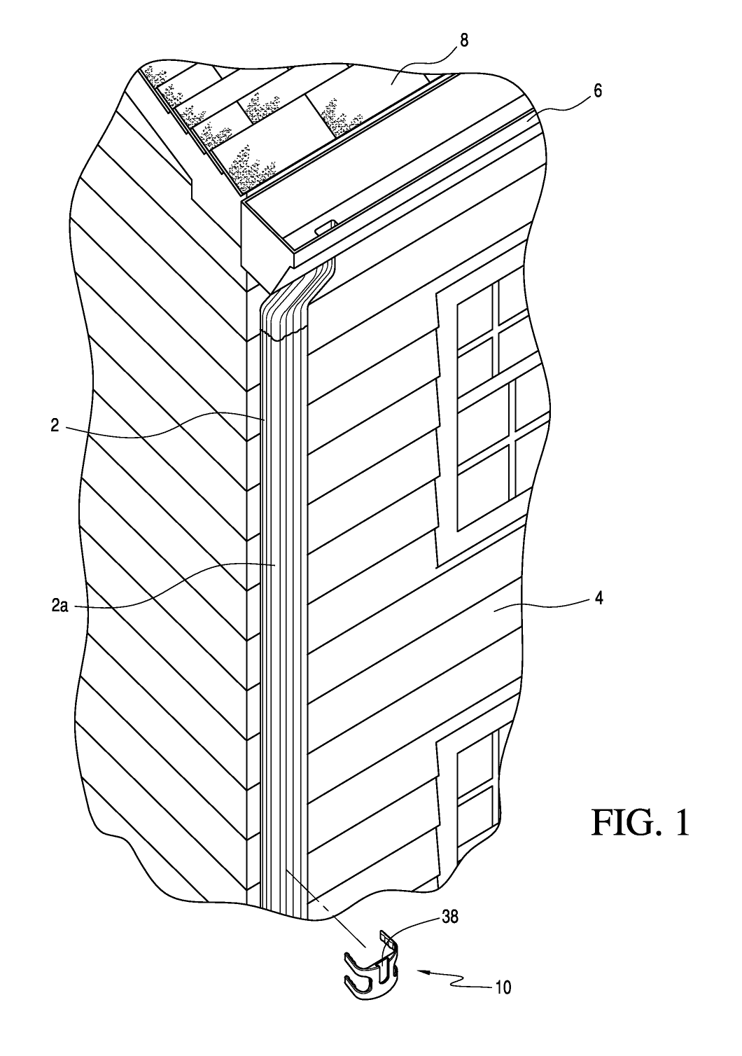

Turning in detail to the drawings, FIGS. 1-12 show various configurations of mounting clips 10, 100, 200, 300, 400, 500, 600, 700. The mounting clips and decorative mounting articles described herein are configured for mounting onto a downspout or other comparable vertically disposed mounting surface. As used herein, the term “downspout” should be broadly construed as any conduit that may couple to a roof gutter or drainage system on a building structure. Moreover, as used here, the term “building structure” should be construed broadly as any structure having walls suitable for installation of a downspout or comparable vertically disposed mounting surface. Such structures are therefore not limited to stationary building structures, but may also include boats, mobile homes, and recreational vehicles, which may be suitable for habitation.

It is also within the scope of this invention for the mounting clips and decorative mounting articles to be mounted on alternative mounting surfaces other than vertically disposed mounting surfaces. Alternative mounting surfaces may comprise, for example and without limitation, hand railings, deck railings, porch railings, whether horizontally disposed or angularly disposed, trees, poles, various sizes of lumber, and doorways.

The mounting clips and decorative mounting articles shown may be manufactured from a variety of material types. However, in preferred configurations, the clips and articles are manufactured with flexible materials, including, but not limited to, elastomeric, thermoplastic, and metallic materials. A representative metal is aluminum. Representative thermoplastic materials are polyvinylchloride (PVC) and polyurethane. A representative elastomeric material is rubber or latex rubber. Such materials should be substantially weather resistant such that they are not subject to significant corrosion upon frequent exposure to rain, snow, ice, humidity, etc. Alternatively, the materials may be impregnated with or coated with protective materials, such as but not limited to, antimicrobials, UV-resistants and/or flame retardants, which provide sufficient weather resistance.

Mounting clips and decorative mounting articles may also be manufactured with different types of colors such that they blend with the building structure or downspout material. Alternatively, mounting clips and decorative mounting articles may be manufactured having a contrasting color, decoration, or pattern that lends to building aesthetics or seasonal decor. For example, mounting clips may have a shape and color that changes the appearance of a downspout to appear from a distance to be a striped candy cane. In addition, mounting clips and decorative mounting articles may have shapes and colors that are complementary to other decor positioned close to the building structure.

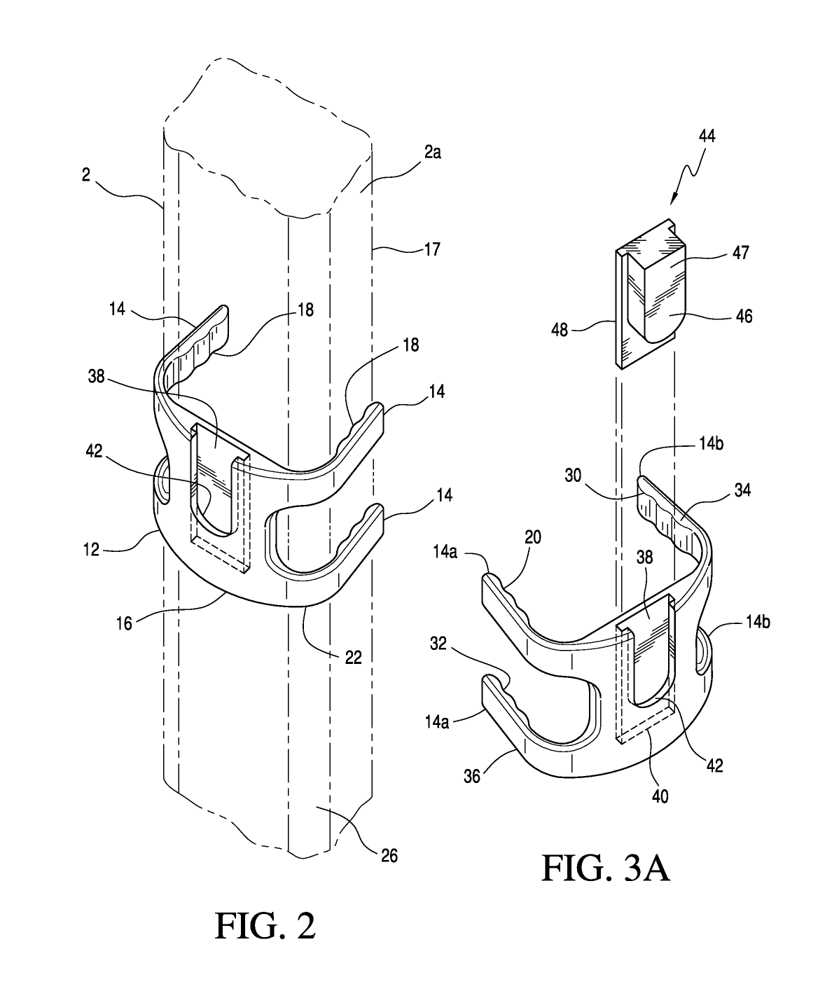

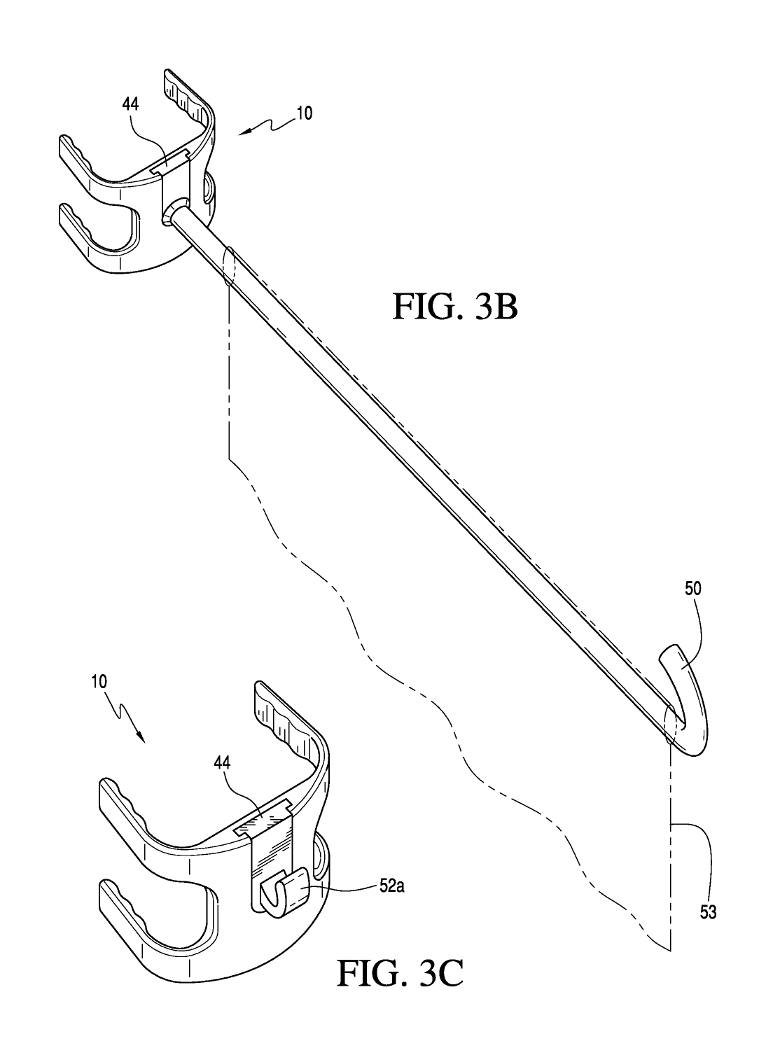

FIGS. 1-3C and 12 show on version of a mounting clip 10 configured for attachment to a mounting surface 2, such as a downspout 2a, a post 2b (FIG. 12), or other comparable mounting surface. The downspout 2a is in a substantially vertical position against a building structure 4 and may be coupled to a horizontally positioned gutter 6, which is coupled to a roof 8 of the building structure. Referring particularly to FIGS. 2 and 3A, in one configuration, the mounting clip 10 includes a frame 12 having a plurality of extending arms 14 and a central portion 16 disposed between at least two of the plurality of extending arms. The frame 12 has a shape that is complementary to a profiled mounting surface 17, which is represented in hidden lines in FIG. 2. A “profiled mounting surface” is defined herein as a surface that engages with complementary engagement portions of a mounting clip or a decorative mounting article, as further described below.

Where the mounting surface 2 is a downspout that has a generally rectangular cross-section with rounded corners, the frame 12 may be substantially u-shaped such that it covers front sections and side sections of the downspout. If the mounting surface, such as a downspout, has a generally circular cross-section, however, the frame may be substantially c-shaped. Other complementary frame configurations may also be realized, depending upon the cross-sectional shape of the mounting surface.

In the configuration shown in FIGS. 1, 2 and 3A, the mounting clip 10 includes at least two extending arms 14 each having an engagement portion 18 with a profiled inner section 20. The clip 10 also includes a corner section 22 that engages with the corners 26 of the mounting surface 2, while the profiled inner sections 20 is configured to engage with a profiled mounting surface 17. The profiled inner section 20 of the extending arm also may include projections 30 and channels 32 that extend from an upper arm edge 34 to a lower arm edge 36.

Opposing extending arms 14a, 14b may be slightly tapered toward one another such that upon installation onto a mounting surface 2, the arms 14a, 14b are pulled apart. During installation, extending arms 14a, 14b may then be released and positioned such that projections 30 and channels 32 of the profiled inner section 20 are in substantial alignment with the profiled mounting surface 17. Thus, when the mounting clip 10 is installed on a downspout, projections 30 fit within or engage recesses or channels of the profiled mounting surface 17, and ridges or raised portions of the profiled mounting surface 17 fit within or engage with channels 32 such that the clip is held onto the surface without the use of fastening elements, such as tape, nails, and screws, or the like. The engagement of the profiled sections 20 of the clip 10 and the mounting surface 17 is such that the clip 10 may be quickly installed onto the mounting surfaces by pushing force, and then in turn quickly removed by pulling the extending arms away from the mounting surface 17. When the clip 10 is mounted on the mounting surface 17, the extending arms 14a, 14b provide sufficient force to hold the clip in place and to support various types of mountable elements 19, including decorations, flag poles, and lights, as further described below. The engagement of the clip 10 to the mounting surface 17 is a snap fit or comparable to a snap fit, and the clip 10 may be installed and removed repeatedly from the engagement to the mounting surface 17.

In the configuration shown in FIGS. 1-3C, the central portion 16 includes a blank receiving area 38, having a varying wall thickness, with at least one wall thickness portion having a greater wall thickness than the extending arm wall thickness. The blank receiving area 38 defines a slotted are 40, having one section with a substantially rectangular shape, and a blank opening area 42. The shapes of the slotted area and the blank opening area shown in FIGS. 1-3C, however, should not be construed as limited. Each of these areas 40, 42 may have any shape that facilitates mating with a blank 44. Mating may occur by slidable engagement, snap engagement, lock and key type arrangements, male and female arrangements, and/or any other engagement method used alone or in combination that allows for mounting of the blank onto the mounting clip.

In the configuration of FIGS. 1-3C, the blank 44 includes a protruding section 46 and a mating section 48. The mating section 48 is configured for positioning within the slotted area 40 such that the blank 44 slides into the blank receiving area 38. The protruding section 46 includes a face portion 47, which is configured for coupling with various types of mountable elements.

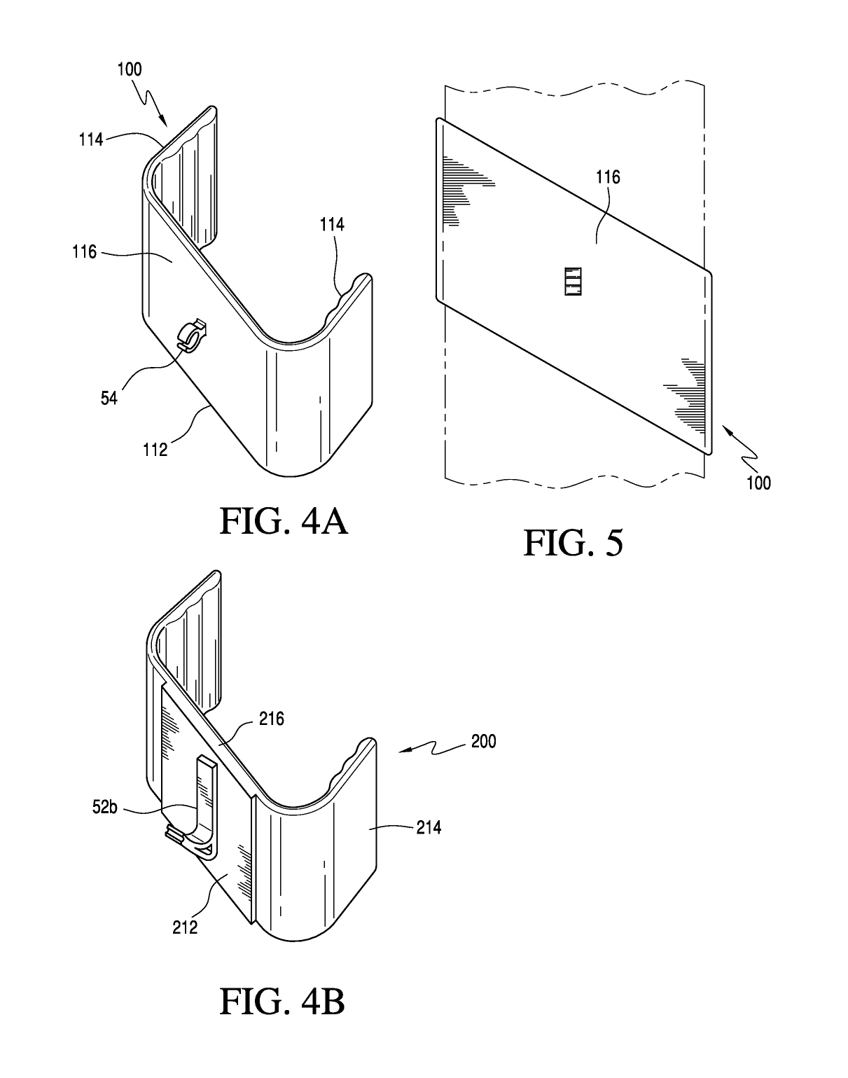

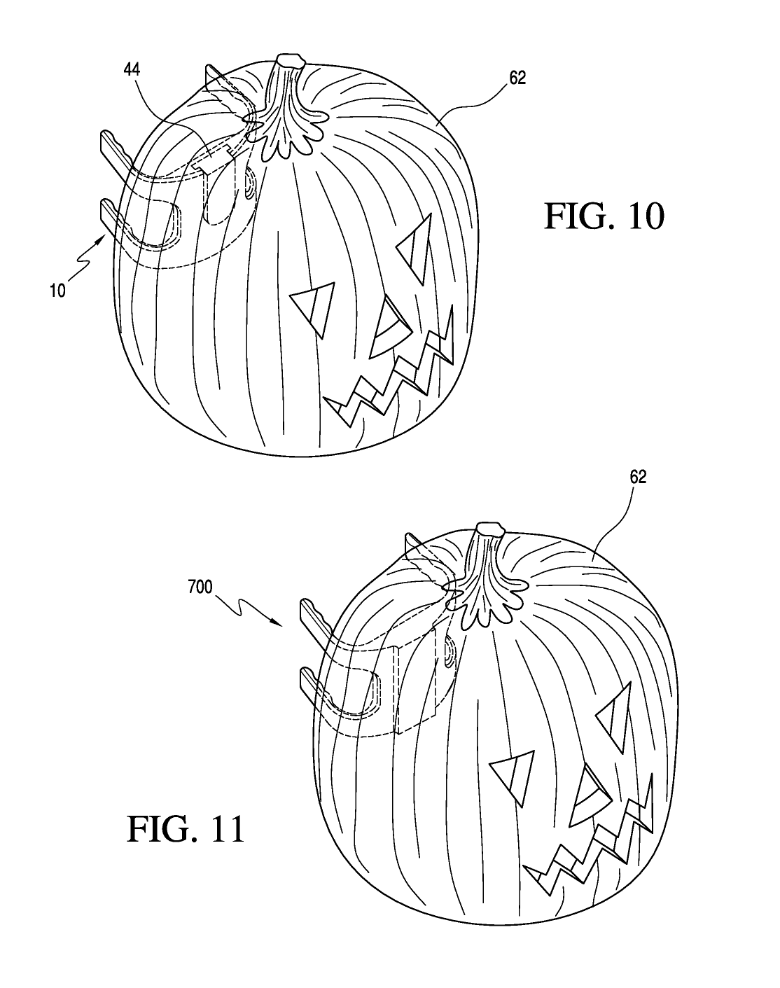

Mountable elements include, but are not limited to, arm attachments 50 (FIG. 3B), hook attachments 52a (FIGS. 3C, 12), 52b (FIG. 4B), 52c (FIG. 8), clip attachments 54 (FIGS. 4A, 5 and 6), plate or bracket attachments 56 (FIG. 7), and decorative articles 700 (FIG. 10). These types of mountable elements 19 allow a user to position flags or banners 53 (FIG. 3B), string lights, security lights, birdhouses, decorative lights, decorative articles, electrical outlets, and any other product type suitable for mounting. In alternative configurations, these types of mountable elements may be integral to the central portion, as shown particularly in FIGS. 4A, 6 and 11. Alternatively, hooks, clips, mounting plates, and similar devices may be directly attached to a central portion on one or more clips, using fastening elements such as adhesives, tapes, and screws. See, e.g., FIG. 7. The central portion 16 of the clip 10 is preferably used as an attachment point for one or more mountable elements. As such, a mountable element may be coupled to the central portion using any viable method. Such methods include use of molding techniques, adhesives, fasteners 58 (FIG. 7), and other types of fastening elements.

FIGS. 4A, 4B and 5 show other configurations of a mounting clip 100, 200 that may attach to a mounting surface 2. Here, each mounting clip includes a frame 112, 212 having two extending arms 114, 214 and an angularly aligned or slanted central portion 116, 216 disposed between the extending arms. When multiple mounting clips of this configuration are coupled to a downspout, the downspout may have a striped appearance when viewed from a distance. For example, where the downspout is white and the clips 100, 200 are red, from a distance, the downspout may look like a candy cane. This type of configuration is therefore particularly suitable for use as a decorative element during the Christmas holidays. FIGS. 4A and 5 show a clip-type attachment 54 which may be used to string lights, garland, ropes, cords, etc. FIG. 4B shows an alligator hook-type attachment 52b, which may also be used to hang lights, garland, ropes, cords, and similar objects.

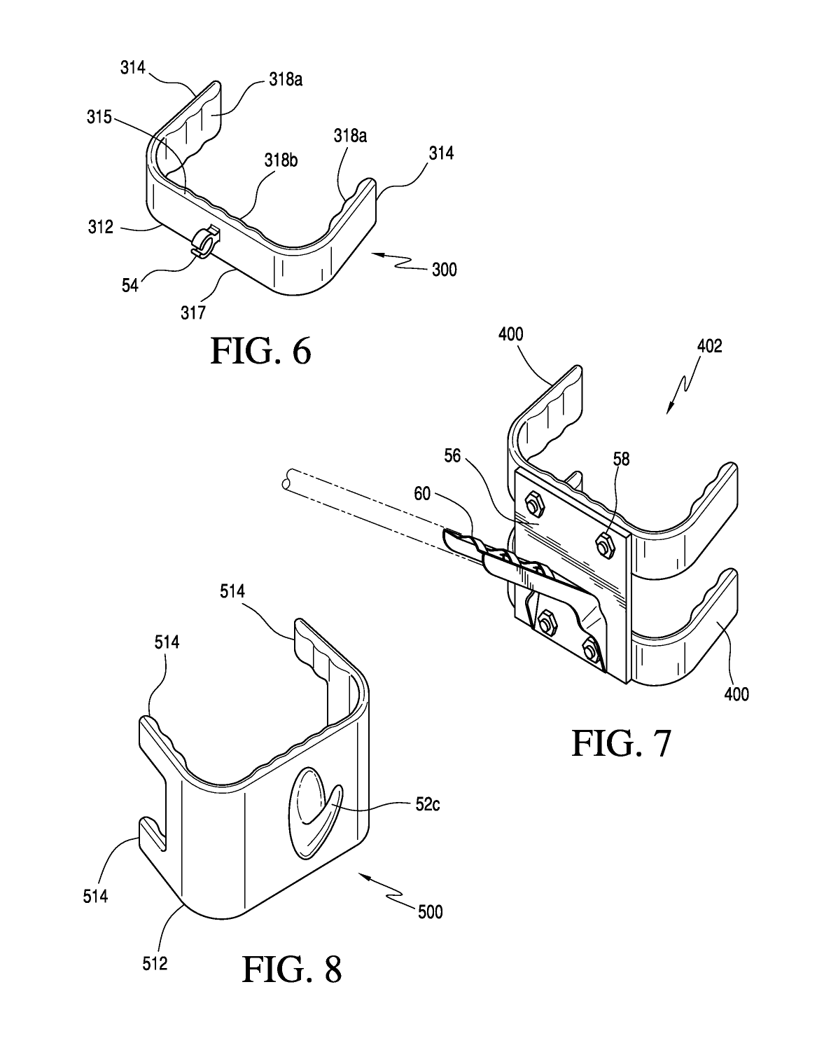

FIG. 6 shows one configuration of a mounting clip 300 having a horizontally positioned central portion 316 and extending arms 314. Here, the central portion of the clip includes an arm engagement portion 318a and a central engagement portion 318b. The central engagement portion extends from an upper face 315 to the lower face 317 of the central portion 316. These engagement portions 218a, 318b provide additional means of retaining the clip 300 onto a mounting surface.

FIG. 7 shows an example of one method of coupling mounting clips 400 to form a mounting clip assembly 402, using a plate or bracket 56. This type of attachment may be used to couple other types of mountable elements such as a flag holder 60, security light brackets, etc., which are normally directly mounted onto vertical surfaces of building structures.

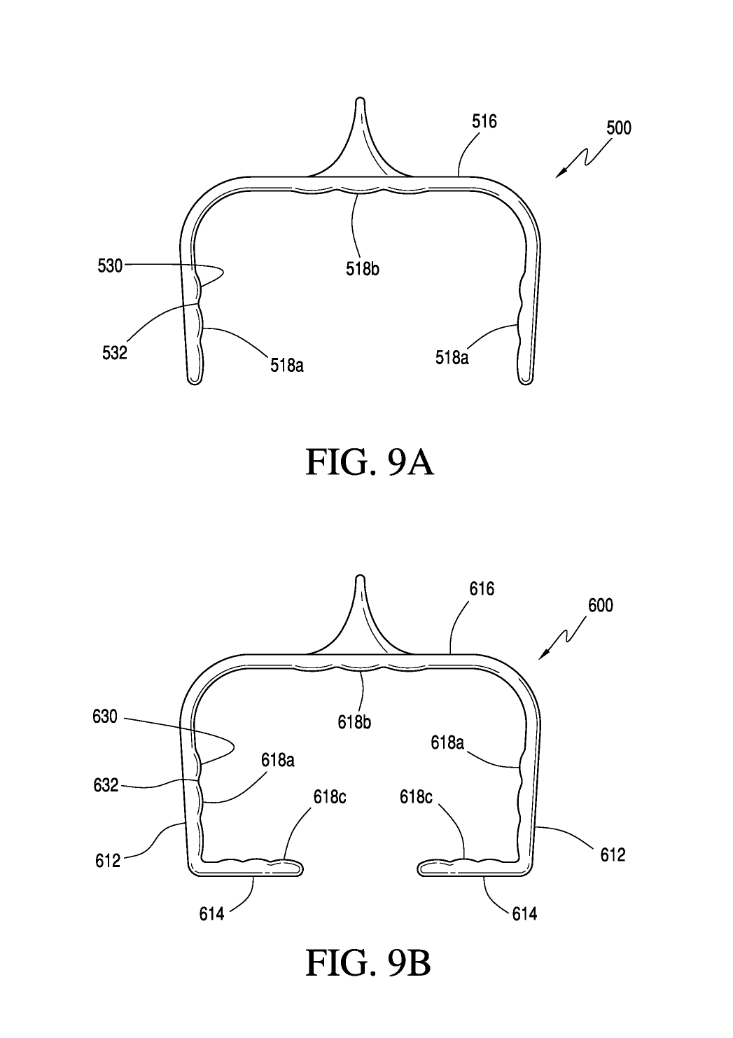

FIGS. 8, 9A and 9B show additional configurations of mounting clips 500, 600. Here, each mounting clip includes a frame 512, 612 having four extending arms 514, 614 and horizontally positioned central portion 516, 616 disposed between the extending arms with engagement portions 518a, 618a. FIGS. 8 and 9A show engagement portions 518a, 518b disposed on profiled inner sections on the extending arm and the central portion. In FIG. 9B, each extending arm 614 is configured to extend around a rear portion of a mounting surface (not shown). As such, this version of the mounting clip 600 includes rear engagement portions 618c. Each engagement portion has projections 530, 630, respectively, separated by channels 532, 632, which facilitate attachment of the mounting clip 500, 600 to a mounting surface.

FIG. 10 shows another configuration of a decorative article 62 suitable for attachment to a mounting clip 10. In FIG. 10, the rear of the decorative article is coupled to a blank 44. Alternatively, a blank may be formed integrally to extend from a surface of a decorative article. Although a pumpkin is shown as the decorative article in this example, any type of decorative article or element may be coupled to the blank 44 or may have a blank integrally formed therein. Other nonlimiting examples of decorative articles include mountable stars, hearts, icicles, snow men, candy canes, reindeer, Santa Clauses, angels, stuffed animals, etc.

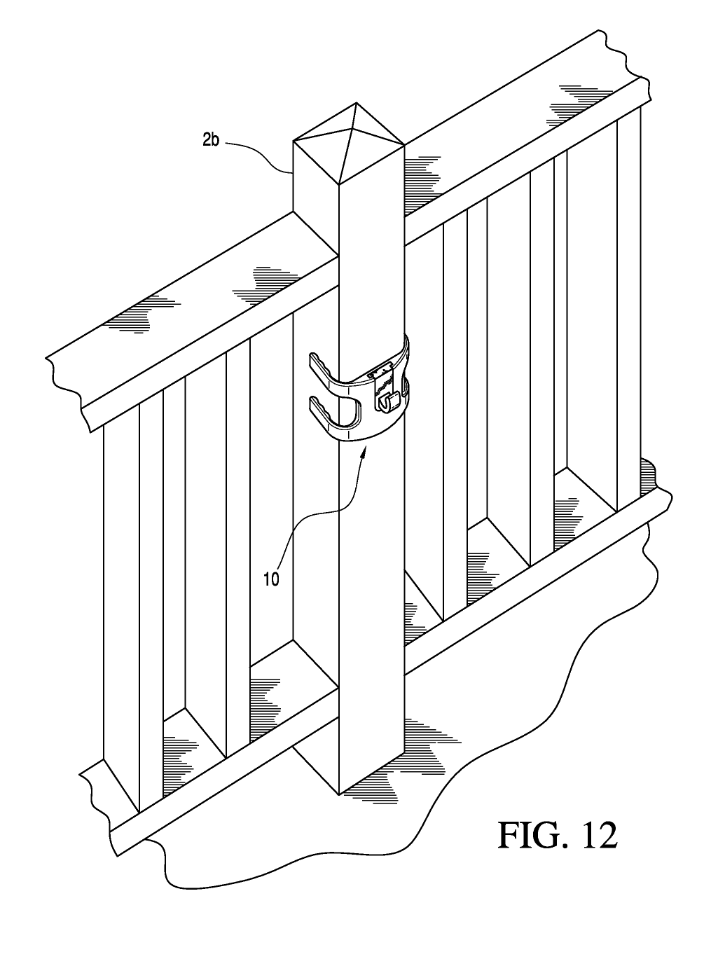

FIG. 11 shows a mounting article 700 integrally formed with the decorative article 62, using any viable technique. Such techniques include, but are not limited to, molding and machining.

The mounting clips shown include engagement portions having shapes, which may be complementary to various types of profiled mounting surfaces. In preferred configurations, extending arms, central portions, and/or rear portions each include respective engagement portions having projections and channels. These respective engagement portions are configured to engage with profiled mounting surfaces such that mounting clips and decorative elements may be coupled to the mounting surfaces without use of other fastening elements.

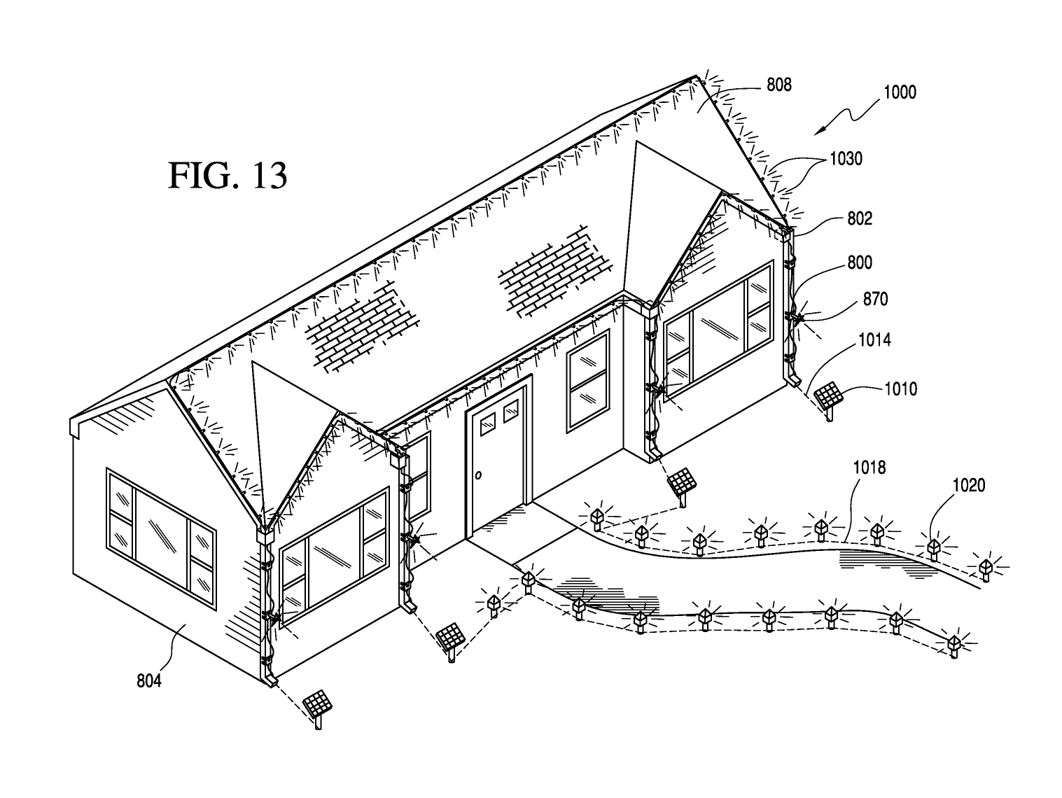

Referring next to FIG. 13, an integrated system 1000 of powered mounting clips 800 and other powered accessories 1020, 1030 is shown. A building structure 804 such as a home as shown in FIG. 13, includes mounting surfaces 802 such as downspouts that are attached or engaged to the building structure or to the gutter system associated with the building structure. The integrated system 1000 illustrated has a series of solar panels 1010 in electrical communication with electrically powered accessories, including staked lighting 1020 and light strands or LED strands 1030. As shown, the staked lighting 1020 is positioned adjacent a front walk or entryway, and the light strands or LED strands 1030 are mounted to the roof 802. Underground or buried wire 1018 links the staked lighting 1020 to the solar panels 1010 or batteries or energy accumulators associated with the solar panels 1010. The underground or buried wire 1018 also links the solar panels 1010 or batteries or energy accumulators associated with the solar panels 1010 to powered mounting clips 800 that have been installed on mounting surfaces 802. Decorative lights 870 may be engaged with the powered mounting clips 800, such as but not limited to, the star-shaped decorative lights shown in FIG. 13. The powered mounting clips 800 are joined in series by wires, and are in turn in electrical communication with the light strands or LED strands 1030.

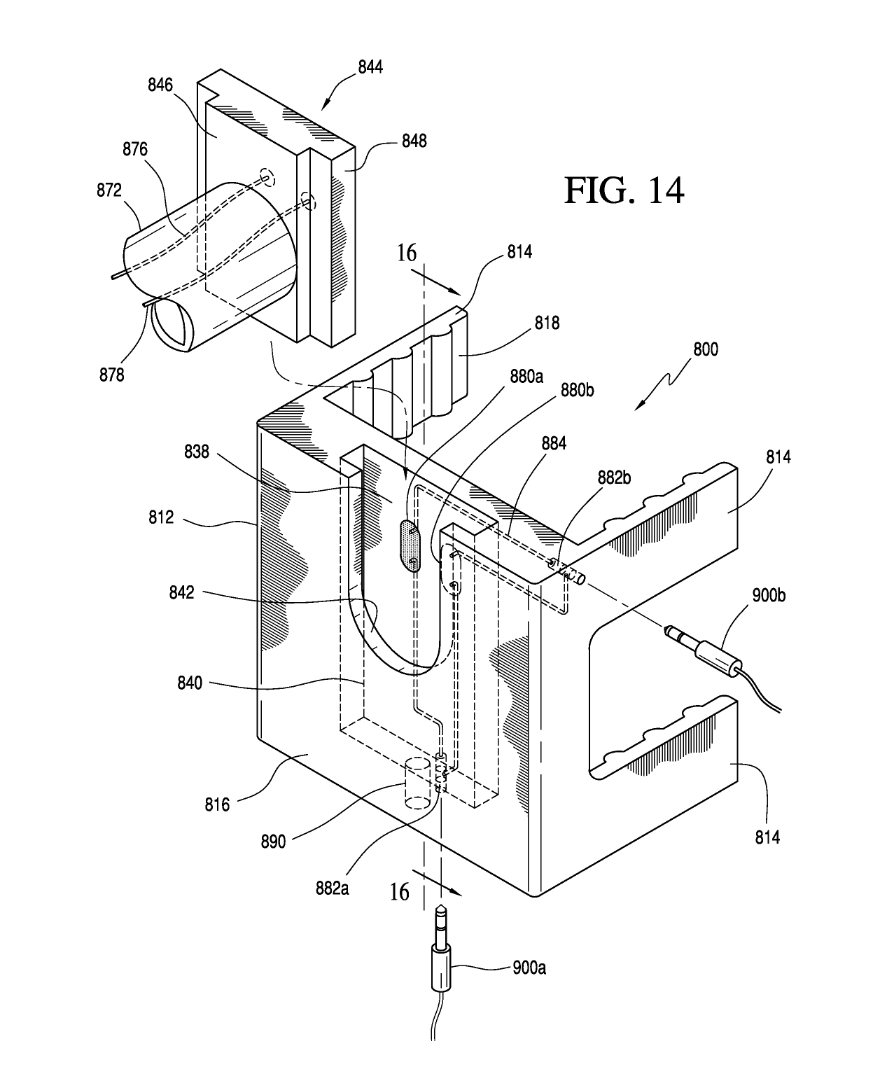

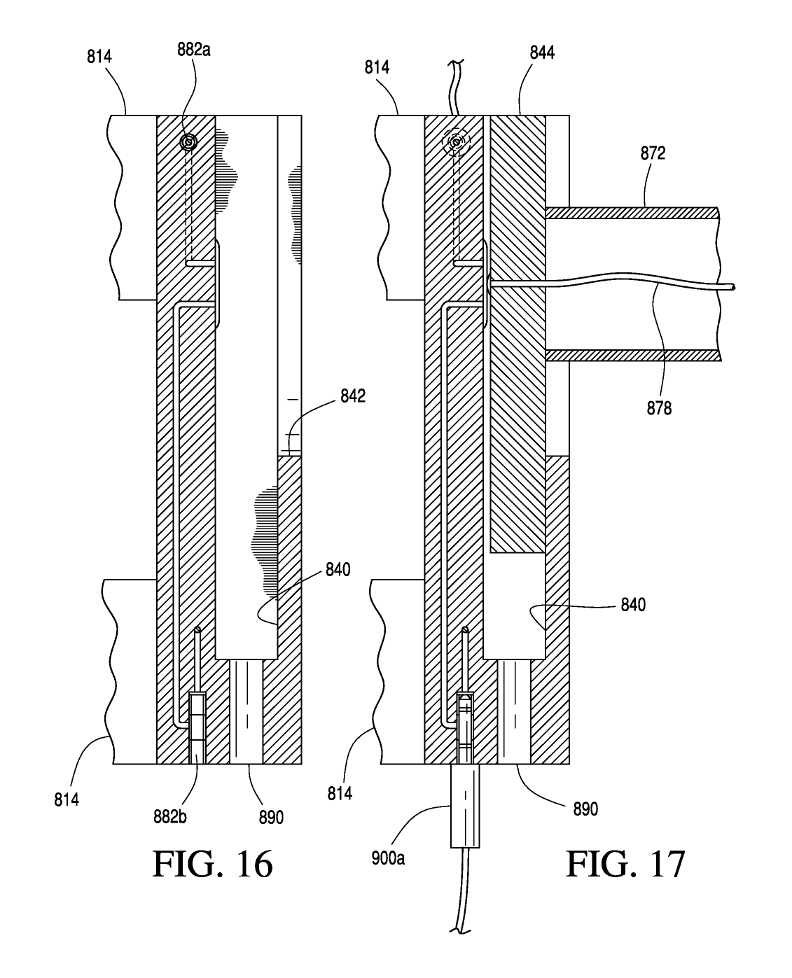

FIGS. 14-17 show a powered mounting clip 800 in more detail. As shown in FIG. 14, a powered mounting clip 800 has a central portion 816 and outwardly extending arms 814. The extending arms 814 have inwardly facing surfaces and outwardly facing surfaces. The inwardly facing surface of the extending arms 814 preferably include engagement portions 818, such as the upstanding ridges alternating with channels as shown in FIG. 14. The central portion 816 of the powered mounting clip 800 defines a blank receiving area 838 having a slotted area 840 and a blank opening area 842. Conductive contacts or contact regions 880a, 880b are found on an inner surface of the blank receiving area 838. The conductive contact regions may be formed of an electrically conductive material, including but not limited to, a metal, such as copper or aluminum, or a conductive plastic, such as Nylon 6/6 with conductive particles dispersed therein.

A drain channel 890 is provided at a bottom portion of the slotted area 840 to drain water that may penetrate into the slotted area 840.

A first male jack or connector 900a engages a female socket 882a. Conductive wires lead through the central portion 816 from the female socket 882a to the conductive contacts or contact regions 880a, 8806. A second male jack or connector 900b engages a female socket 882b. Conductive wires lead through the central portion 816 from the female socket 882b to the conductive contacts or contact regions 880a, 880b.

A blank 844 has a protruding section 846 and a mating section 848. The mating section 848 is of a configuration to be slidably received into the slotted area 840 of the blank receiving area 838. The blank 844 has conductive wires 876, 878 inserted therethrough or held therein. The wires 876, 878 may terminate at one end at contact points (not shown). Attached to or formed integrally with the blank is a post 872 for a decorative light 870 or other powered decorative article.

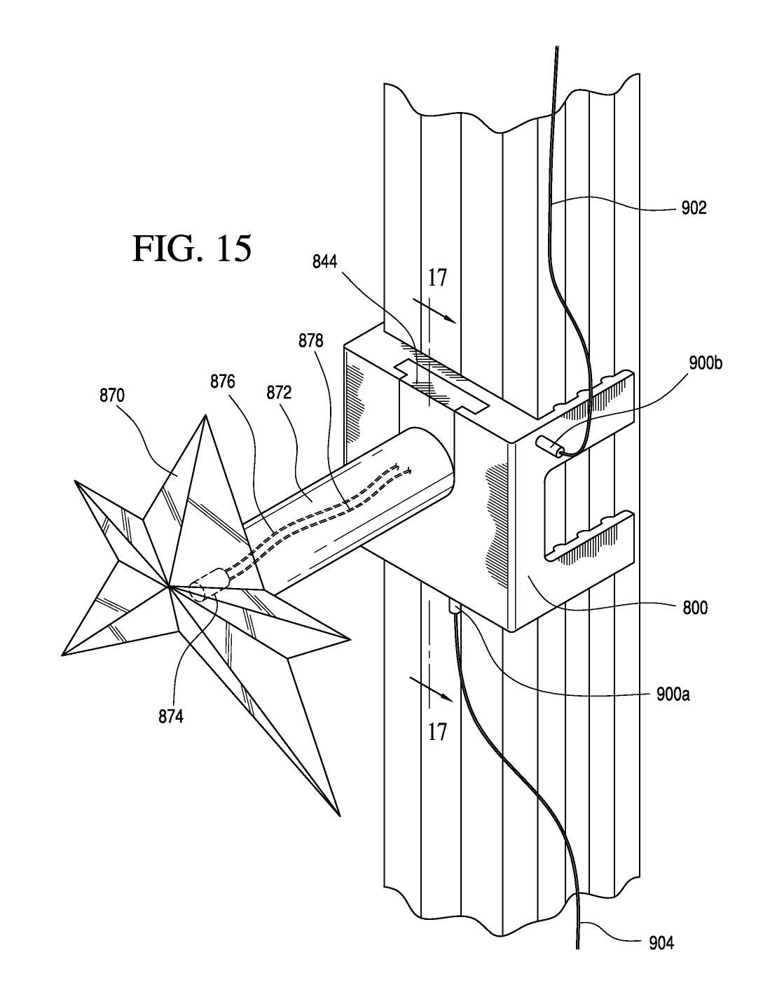

The decorative light 870 is shown in more detail in FIG. 15. The decorative light 870 in this embodiment is formed as a star-shaped globe extending from the post 872. A light or bulb 874, which may be an incandescent bulb, an LED, or other powered structure that emits light, is in electrical communication with the wires 876, 878.

When the blank 844 is slidably engaged into the slotted area 840 of the blank receiving area 838 of the powered mounting clip, the tips or contact points of the wires 876, 878 are in electrical contact with the conductive contacts or contact regions 880a, 880b of the powered mounting clip 800 to complete an electrical circuit. When the male jack connectors 900a, 900b are attached and the wires from such connectors are in communication with a source of electricity, the bulb 874 will receive electricity to illuminate the decorative light 870. While the embodiment shown in FIG. 13 connects the powered mounting clips in series with solar panels 1010, the invention is not limited to use of solar panels. Any source of electricity of suitable voltage may be used to power the powered mounting clips and decorative accessories joined to the powered mounting clips. Electrical connection to a residential power grid is contemplated. As another alternative, batteries other than batteries associated with solar panels may also be suitable power sources.

Thus, various configurations of mounting clips and decorative mounting articles are disclosed. While embodiments of this invention have been shown and described, it will be apparent to those skilled in the art that many more modifications are possible without departing from the inventive concepts herein. The invention, therefore, is not to be restricted except in the spirit of the following claims.

### GLOSSARY

2 mounting surface
2a downspout
2b post
4 building structure
8 roof
10 mounting clip
12 frame
14, 14a, 14b extending arms
16 central portion
17 profiled mounting surface
18 engagement portion
19 mountable element
20 inner surface or section
22 corner section
26 corner of mounting surface
30 projections
32 channels
34 upper arm edge
36 lower arm edge
38 blank receiving area
40 slotted area
42 blank opening area
44 blank
46 protruding section
47 face portion
48 mating section
50 arm attachments
52a, 52b, 52c hook attachments
54 clip attachment
56 plate or bracket attachment
58 fastener
62 decorative article
100 mounting clip
112 frame
114 extending arm
116 central portion
200 mounting clip
212 frame
214 extending arm
216 central portion
300 mounting clip
314 extending arm
316 central portion
317 lower face
318a, 318b engagement portions
400 mounting clip
402 mounting clip assembly
500 mounting clip
512 frame
514 extending arm
516 central portion
518a, 518b engagement portions
530 projections
532 channels
600 mounting clip
612 frame
614 extending arm
616 central portion
618a, 618b engagement portions
630 projections
632 channels
700 mounting article
800 powered mounting clip
802 mounting surface
804 building structure
808 roof
812 frame
814 extending arms
816 central portion
818 engagement portion
838 blank receiving area
840 slotted area
842 blank opening area
844 blank
846 protruding section
848 mating section
870 decorative light
872 post attachment
874 light or bulb
876 wire
878 wire
880a, 880b conductive contact region
882a, 882b female receiving plug
884 wire
890 drainage hole
900a, 900b male jack
902 wire
904 wire
1000 integrated system of powered mounting clips and other powered accessories
1010 solar panel
1014 wire
1018 wire
1020 staked lights
1030 bulbs on light string

1. A mounting clip (800) for a decorative article, comprising:
a frame (812) with arms (814) extending therefrom adapted to removably attach the frame to a mounting surface, said frame defining a slotted area (840) adapted to receive a blank (844) for connection to a decorative article;
a first conductive contact region (880a) disposed within the slotted area and adapted for forming an electrical connection in series with a first electrical connector (900a) and a second electrical connector (900b); and
a second conductive contact region (880b) disposed within the slotted area and adapted for forming an electrical connection in series with the first electrical connector (900a) and the second electrical connector (900b).

2. The mounting clip of claim 1, wherein the first electrical connector comprises a male jack with wire leading therein in combination with a female plug (882a) disposed within the frame.

3. The mounting clip of claim 1, wherein the second electrical connector comprises a male jack with wire leading therein in combination with a female plug (882b) disposed within the frame.

4. The mounting clip of claim 1, wherein the first and second conductive contact regions are disposed in spaced apart relation at a rear surface of the slotted area, and are adapted for electrical communication with conductive projections or points of the decorative article.

5. The mounting clip of claim 1, wherein the first and second conductive contact regions comprise a conductive material selected from the group consisting of copper, aluminum and conductive plastic.

6. The mounting clip of claim 1, further comprising a blank (844) and an associated decorative article (870).

7. The mounting clip of claim 6, wherein the decorative article (870) comprises a light bulb, a string of light bulbs, an LED, a string of LEDs, or a powered aspect or appendage of a holiday decoration.

8. A system (1000) of powered mounting clips (800), comprising:
a first mounting clip (800) for a decorative article (870), said first mounting clip having a frame (812) with arms (814) extending therefrom adapted to removably attach the frame to a mounting surface, said frame defining a slotted area (840) adapted to receive a blank (844) for connection to the decorative article, at least a first conductive contact region (880a) and a second conductive contact region (880b) disposed within the slotted area, a first electrical connector (900a) in electrical connection with the first conductive contact region and the second conductive contact region, and a second electrical connector (900b) in electrical connection with the first conductive contact region and the second conductive contact region;
a second mounting clip for a decorative article, said second mounting clip having a frame with arms extending therefrom adapted to removably attach the frame to a mounting surface, said frame defining a slotted area adapted to receive a blank for connection to a decorative article, at least a first conductive contact region and a second conductive contact region disposed within the slotted area, a first electrical connector in electrical connection with the first conductive contact region and the second conductive contact region, and a second electrical connector in electrical connection with the first conductive contact region and the second conductive contact region; and
an electrical connection (902) between said first mounting clip and said second mounting clip.

9. The system of claim 8, further comprising:
a solar panel (1010);
a battery to store accumulated electrical energy;
an electrical connection between the solar panel and the battery; and
an electrical connection (1018) between the battery and the first mounting clip.

10. The system of claim 9, further comprising a second solar panel, a second battery, and an electrical connection between the second solar panel and the second battery.

11. The system of claim 8, further comprising a decorative article (870) joined to or associated with the blank (844) , wherein the blank is engagable with the slotted area (840) of the first mounting clip.

12. The system of claim 11, wherein the decorative article comprises a powered element that is in electrical communication with the first and second conductive contacts of the first mounting clip.

13. The system of claim 12, further comprising a decorative article joined to or associated with the blank, wherein said blank is engagable with the slotted area of the second mounting clip, and wherein the decorative article comprises a powered element that is in electrical communication with the first and second conductive contacts of the second mounting clip.

14. The system of claim 8, further comprising a powered element that is in electrical communication with either the second electrical conductor of the first mounting clip or the second electrical conductor of the second mounting clip.

15. The system of claim 12, wherein the powered element is selected from the group consisting of: a light bulb, a string of light bulbs, an LED, a string of LEDs, and a powered aspect or appendage of a holiday decoration.

16. The system of claim 12, further comprising two or more additional powered elements (1020, 1030) in electrical communication with one another, with at least one of said two or more additional powered elements in electrical communication with one of the electrical conductors of either the first or the second mounting clip.
